(19) United States
(12) Patent Application Publication
(10) Pub. No.: US 2005/0246730 A1
(43) Pub. Date: Nov. 3, 2005

(54) Magneto optical recording system

(75) Inventors: Frank Cornelis Penning, Eindhoven (NL); Ferry Zijp, Eindhoven (NL); Aukje Arianne Annette Kastelijn, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklijke phillips electronics n.v.

(21) Appl. No.: 10/523,426

(22) PCT Filed: Jul. 16, 2003
(86) PCT No.: PCT/IB03/03242

§ 371 Date: Jan. 28, 2005

(30) Foreign Application Priority Data
Aug. 1, 2002 (EP) 02078158.9

(51) Int. Cl. G11B 7/085

(52) U.S. Cl. 720/685

(57) ABSTRACT

An actuator (6) for a magneto optical recording apparatus (1) comprises an actuator base (20); a platform (30) movably coupled to said actuator base (20); at least one actuator coil (31) supported by said platform (30); at least one writing coil (43) supported by said platform (30). One common conductor (22a; 22b) conducts actuator coil drive signals as well as writing coil drive signals from said actuator base (20) to said platform (30).

The present invention relates in general to a magneto optical recording system, suitable for writing information into a storage medium utilizing a magneto optical effect. The present invention relates more specifically to a magneto optical head used in such system.

Magneto optical recording systems in general are known. For instance, reference is made to EP-0.432.312-A1. Typically, the storage medium is in the shape of a disc, which is made to rotate so that a magneto optical head can follow a circular or spiral-shaped track on a surface of the disc. Information is written into a portion of the disc material by changing at least one optical property of this disc material portion, such as polarization, reflectivity, etc, by suitably magnetizing this disc material portion. To this end, the magneto optical head comprises controllable magnetizing means for applying a controlled magnetic field to an area of the disc.

The magneto optical discs typically comprise a material that is difficult to magnetize at relatively low temperatures, and more easily magnetizable at elevated temperatures. Further, it is desirable to achieve a high information density, i.e. to be able to selectively magnetize a disc portion having a very small size. This effect is obtained by optically defining the disc portion to magnetize, using a laser beam with a very small focal spot, the laser beam having sufficient intensity to heat the disc material to a required temperature. To this end, the magneto optical head also comprises controllable optical means for directing a controlled laser beam to a portion of the disc.

During operation, the light beam should remain focussed on the disc, and the focal spot should remain aligned with a track or should be capable of being positioned with respect to a new track. To this end, the magneto optical head also comprises a movable platform carrying at least some components of the controllable magnetizing means and of the controllable optical means. In order to keep the mass (weight) of the movable platform as low as possible, the movable platform typically only carries an objective lens of the optical means and a coil of the magnetizing means.

The platform is held with respect to an actuator base by a plurality of spring wires, which allow movement of the platform in the radial direction and in the focal direction (i.e. along the optical axis). For moving the platform with respect to the actuator base, the magneto optical head also comprises a focal actuator and a radial actuator, which may be integrated into one combined focal/radial actuator, and which hereinafter will together simply be referred to as “actuator”. The actuator comprises at least one actuator component fixed to the movable platform and at least one actuator component fixed to the actuator base. For instance, the movable platform may comprise one or more actuator coils cooperating with one or more magnets fixed to the actuator base. Alternatively, the movable platform may comprise one or more magnets cooperating with one or more actuator coils fixed to the actuator base.

In order to keep the mass (weight) of the movable platform as low as possible, a coil driver, i.e. a device generating drive signals for the coil of the magnetizing means, is located outside the platform, for instance fixed to said actuator base or to a device frame. Then, a problem to be solved is the transfer of the coil drive signals from the coil driver to the coil. This requires electrically conductive leads, bridging the gap between the actuator base and the actuator platform.

It is possible to use separate wiring, but this is undesirable as the wiring might affect the accuracy and the response speed of the actuator. Further, such wiring will add to the resistance, capacitance and inductance of the coil circuit, which will lower the maximum resonance frequency of the coil and hence will affect the frequency response of the coil.

Thus, it is generally desirable to have the number of mechanical connections (leads, wires), bridging the gap between the actuator base and the actuator platform, to be as low as possible. Therefore, an objective of the present invention is to provide a way of transferring high frequency writing coil drive signals from the coil driver to the writing coil without using a dedicated wire for this purpose.

According to an important aspect of the present invention, at least one of the spring wires is electrically conductive and is used as physical conductor for transferring writing coil drive signals. Then, according to the present invention, said spring wires have a (high frequency) electrical function as well as a mechanical function.

In the case where the movable platform comprises one or more actuator coils, spring wires may also carry current for energizing the actuator coils. Since it is generally desirable to keep the number of wire springs as low as possible, it is generally not desirable to have separate wire springs dedicated to carrying actuator coil energizing current and separate wire springs dedicated to carrying writing coil drive signals. In these cases, it is generally desirable to have the number of spring wires correspond to the minimum number necessary for energizing the actuator coils, which means that, in a certain magneto optical head design, all spring wires are already used for carrying actuator drive signals.

Then, according to a preferred aspect of the present invention, at least one of the spring wires is used as common physical conductor for transferring actuator drive signals as well as writing coil drive signals.

These and other aspects, features and advantages of the present invention will be further explained by the following description taken with reference to the drawings, in which same reference numerals indicate same or similar parts, and in which:

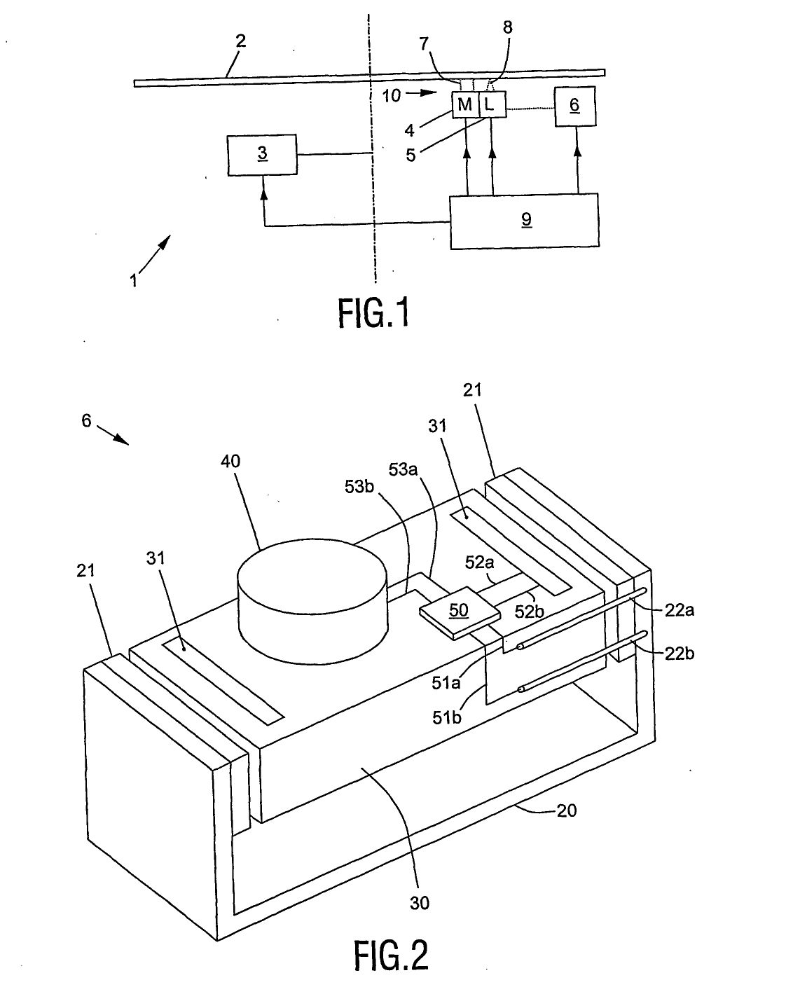

FIG. 1 schematically illustrates a magneto optical recording apparatus;

FIG. 2 is a perspective view, schematically illustrating a lens and coil assembly with an actuator;

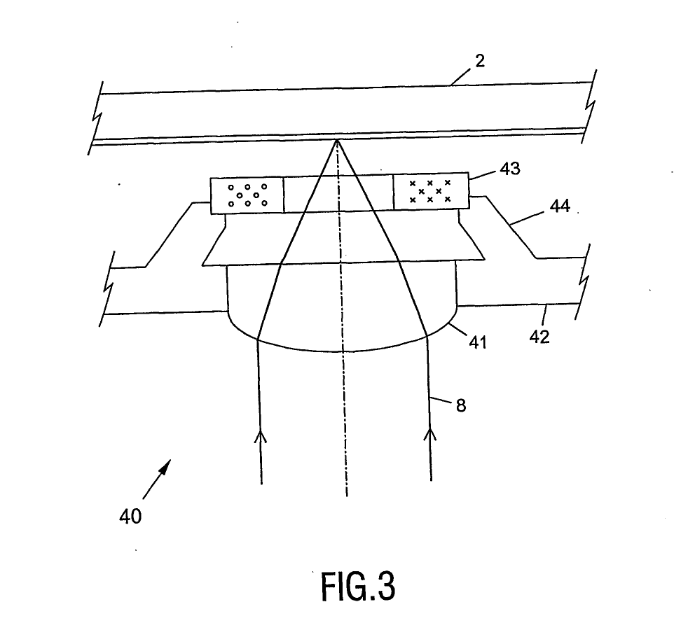

FIG. 3 schematically shows a cross section of a lens and coil assembly for a magneto optical recording apparatus;

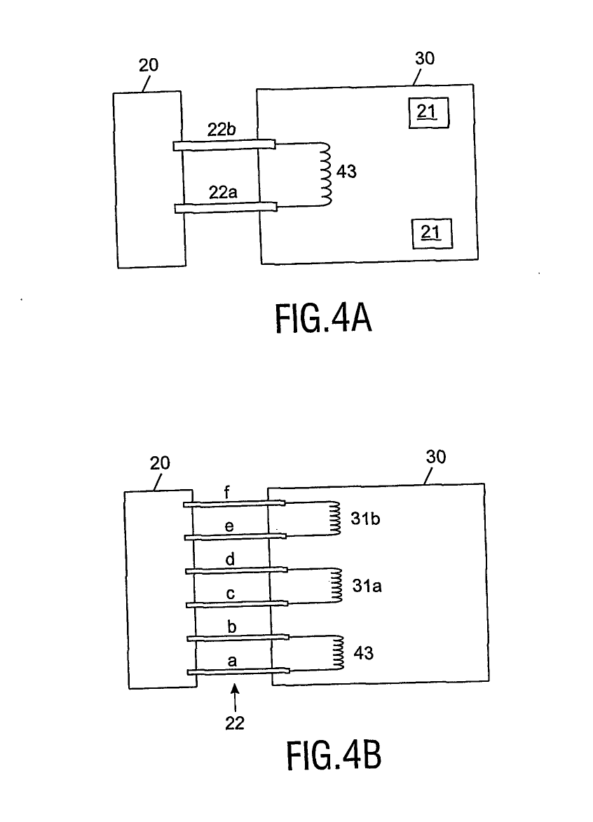

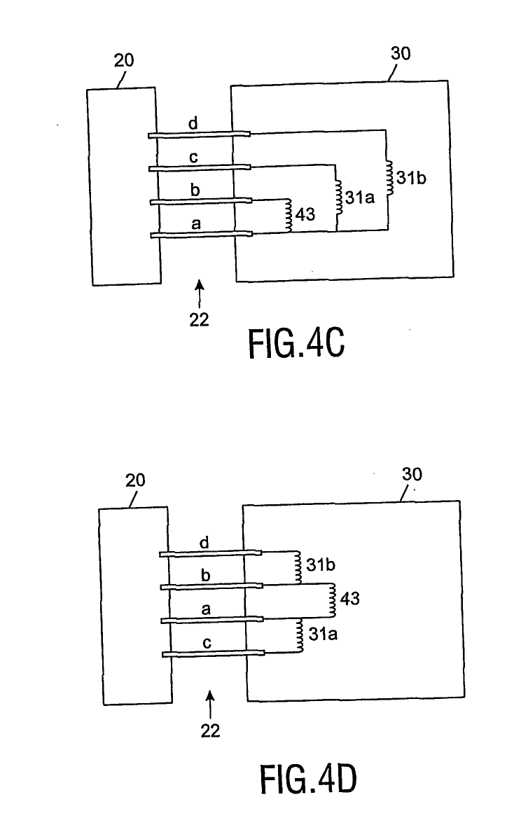

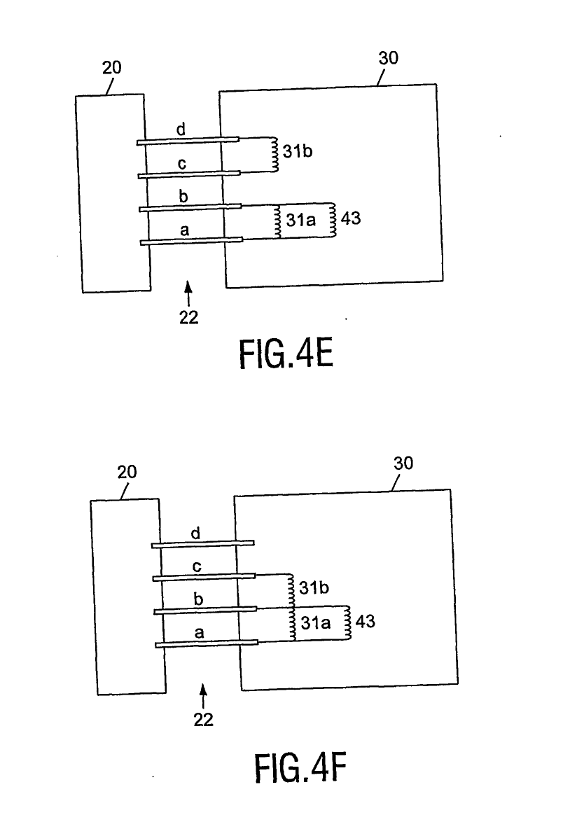

FIGS. 4A-F schematically illustrate several possibilities for mounting and feeding coils; and

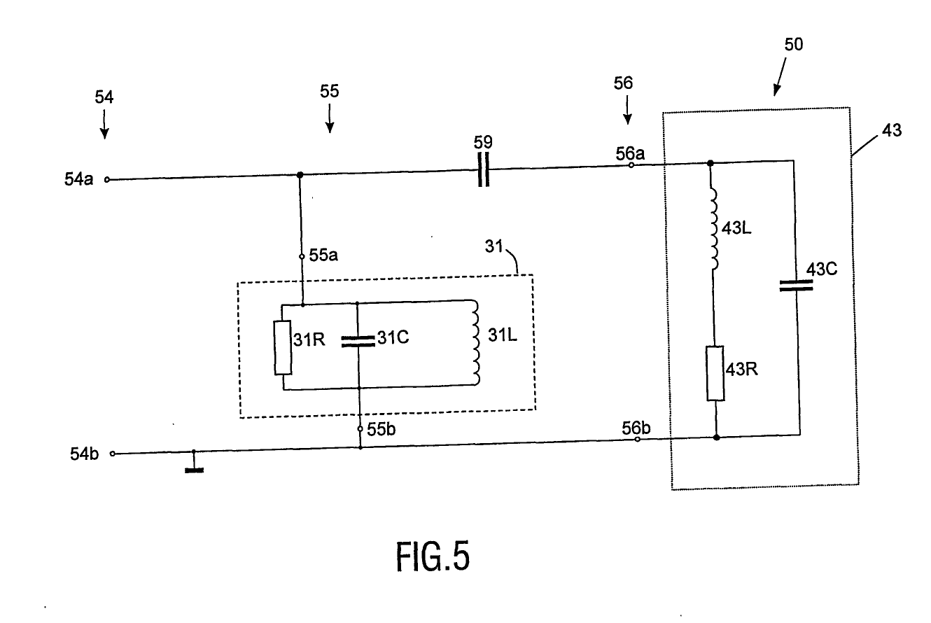

FIG. 5 schematically shows an embodiment of a filter.

FIG. 1 schematically illustrates a magneto optical recording apparatus 1, capable of writing information into a disc-shaped storage medium 2. The apparatus 1 comprises rotating means 3 for receiving and rotating the disc 2. The apparatus 1 further comprises a magneto optical head 10, comprising controllable magnetizing means 4 for applying a controlled magnetic field 7 to an area of the disc 2, and controllable optical means 5 for directing a controlled laser beam 8 to a portion of the disc 2. The apparatus 1 further comprises an actuator 6 for moving the magneto optical head 10 in a direction parallel to the optical axis of laser beam 8 and in a radial direction of the disc 2. The apparatus 1 further comprises a control unit 9 for controlling the rotating means 3, the magnetizing means 4, the optical means 5, and the actuator 6. Since a magneto optical recording apparatus in general is known, it is not necessary here to give a more detailed description of its design and operation.

In FIG. 2, an actuator 6 is schematically illustrated in more detail. The actuator 6 comprises an actuator base 20 and a platform 30 movable with respect to the base 20. The actuator base 20 is intended for mounting on an actuator sledge or the like (not shown for sake of simplicity). The platform 30 carries a lens and coil assembly 40 of the optical head 10, as will be explained in more detail with reference to FIG. 3.

FIG. 3 schematically shows a cross section of a part of an embodiment of a lens and coil assembly 40, which is to be mounted on or integrated in a movable platform 30 of the magneto optical head 10 of the magneto optical recording apparatus 1. An objective lens 41 is mounted in a lens holder 42. A writing coil 43 is supported by a support 44, aligned with the objective lens 41, and is located at that side of the lens which faces the disc 2.

Returning to FIG. 2, the platform 30 is held with respect to the actuator base 20 by a plurality of spring wires 22, which allow movement of the platform 30 in directions perpendicular to the central axes of said spring wires. In FIG. 2, only two spring wires 22a and 22b are shown.

The optical head 10 further comprises a driver for driving the writing coil 43, which writing coil driver is not shown for sake of simplicity. For instance, said writing coil driver may be fixed to said actuator base.

According to the principles of the present invention, at least two of said spring wires 22a and 22b are electrically conductive and carry the writing coil drive signals from the actuator base 20 to the platform 30.

For moving the platform 30 with respect to the actuator base 20, the actuator 6 comprises actuator magnets 21 and focus actuator coils 31a and tracking actuator coils 31b, which together will be referred to as actuator coils 31, cooperating with said magnets 21.

The actuator 6 further comprises an actuator coil driver for energizing the actuator coils 31, which actuator coil driver is not shown for sake of simplicity. For instance, said actuator coil driver may be fixed to said actuator base.

In a possible embodiment of the actuator in accordance with the present invention, the platform 30 carries the actuator magnets 21, whereas the actuator base 20 carries the actuator coils 31. FIG. 4A is an electrical diagram schematically illustrating this embodiment. In FIG. 4A, the writing coil 43 is shown as mounted on the platform 30, together with magnets 21. Two electrically conductive spring wires 22a and 22b are shown, electrically connected in series with the writing coil 43, mechanically connecting the platform 30 to the actuator base 20. Any possible further spring wires are not shown in FIG. 4A.

In the embodiment as illustrated in FIG. 2, the actuator base 20 carries the actuator magnets 21, whereas the platform 30 carries the actuator coils 31. In that case, actuator coil drive signals need to be communicated to the actuator coils 31. Preferably, in accordance with the principles of the present invention, electrically conductive spring wires are also used as current path for the actuator coil drive signals.

In case the number of spring wires 22 is sufficient, it is possible to use different spring wires for the actuator coil drive signals and the writing coil drive signals. FIG. 4B is an electrical diagram schematically illustrating this embodiment. In FIG. 4B, the writing coil 43 is shown as mounted on the platform 30, together with actuator coils 31a and 31b. Six electrically conductive spring wires 22a-f are shown, mechanically connecting the platform 30 to the actuator base 20. A first pair of spring wires 22a-b are electrically connected in series with the writing coil 43. A second pair of spring wires 22c-d are electrically connected in series with the focus actuator coil 311a A third pair of spring wires 22e-f are electrically connected in series with the tracking actuator coil 31b.

However, in a practical embodiment, only four spring wires are present. Therefore, in accordance with a preferred embodiment of the present invention, at least one of the spring wires is used as common physical conductor for transferring actuator drive signals as well as writing coil drive signals.

FIG. 4C is an electrical diagram schematically illustrating a first embodiment comprising four electrically conductive spring wires 22a-d, mechanically connecting the platform 30 to the actuator base 20. A set of first and second spring wires 22a-b are electrically connected in series with the writing coil 43. The focus actuator coil 31a has one terminal connected to a separate third spring wire 22c, and has another terminal connected to said first spring wire 22a. The tracking actuator coil 31b has one terminal connected to a separate fourth spring wire 22d, and has another terminal also connected to said first spring wire 22a Thus, said first spring wire 22a acts as a common conductor for writing coil drive signals as well as for focus actuator drive signals as well as for tracking actuator drive signals. Typically, this common conductor 22a will be connected to mass.

FIG. 4D is an electrical diagram schematically illustrating a second embodiment comprising four electrically conductive spring wires 22a-d, mechanically connecting the platform 30 to the actuator base 20. A set of first and second spring wires 22a-b are electrically connected in series with the writing coil 43. The focus actuator coil 31a has one terminal connected to a separate third spring wire 22c, and has another terminal connected to said first spring wire 22a. The tracking actuator coil 31b has one terminal connected to a separate fourth spring wire 22d, and has another terminal connected to said second spring wire 22b. Thus, said first spring wire 22a acts as a common conductor for writing coil drive signals as well as for focus actuator drive signals, whereas said second spring wire 22b acts as a common conductor for writing coil drive signals as well as for tracking actuator drive signals.

Now, only one of said common conductors, for instance conductor 22a, can be connected to mass. Then, problems of crosstalk between tracking actuator coil 31b and writing coil 43 may arise. Normally, the high-frequency signals for the writing coil 43 will hardly pass the tracking actuator coil 31b, considering that the tracking actuator coil 31b has a relatively high inductance. On the other hand, the writing coil 43 has a relatively low inductance so that the low-frequency signals for the tracking actuator coil 31b may flow through the writing coil 43, which might be heated and even be damaged by the resulting large current intensities. In order to prevent this, a small filter capacitor may be connected in series with the writing coil 43, between the writing coil 43 and the node to the tracking actuator coil 31b, as will be explained later in more detail.

In the above embodiments, each of the actuator coils has one spring wire dedicated solely to conducting the corresponding actuator drive signal. It is, however, also possible to have one actuator coils connected to the two spring wires conducting the writing coil drive signals. FIG. 4E is an electrical diagram schematically illustrating a third embodiment comprising four electrically conductive spring wires 22a-d, mechanically connecting the platform 30 to the actuator base 20. A set of first and second spring wires 22a-b are electrically connected in series with the writing coil 43. The focus actuator coil 31a is also connected to said first and second spring wires 22a-b, in parallel to the writing coil 43. The tracking actuator coil 31b has one terminal connected to a separate third spring wire 22c, and has another terminal connected to a separate fourth spring wire 22d. Thus, said first spring wire 22a acts as a common conductor for writing coil drive signals as well as for focus actuator drive signals; the same applies to said second spring wire 22b.

As mentioned above with reference to the embodiment illustrated in FIG. 4D, in order to prevent the low-frequency focus actuator drive signals from flowing through the relatively low-inductance writing coil 43, a small filter capacitor may be connected in series with the writing coil 43, between the writing coil 43 and the node to the focus actuator coil 31a, as will be explained later in more detail.

FIG. 4F is an electrical diagram schematically illustrating a third embodiment comprising four electrically conductive spring wires 22a-d, mechanically connecting the platform 30 to the actuator base 20. A set of first and second spring wires 22a-b are electrically connected in series with the writing coil 43. The focus actuator coil 31a is also connected to said first and second spring wires 22a-b, in parallel to the writing coil 43. The tracking actuator coil 31b has one terminal connected to a separate third spring wire 22c, and has another terminal connected to said second spring wire 22b. Thus, said first spring wire 22a acts as a common conductor for writing coil drive signals as well as for focus actuator drive signals, whereas said second spring wire 22b acts as a common conductor for writing coil drive signals as well as for focus actuator drive signals as well as for tracking actuator drive signals. Since in this embodiment the fourth spring wire 22d is not used for conducting any of the said electrical signals, it may be implemented non-conductive or, if desired, it may be omitted completely, thus yielding an embodiment comprising three spring wires only.

As mentioned above with reference to the embodiment illustrated in FIG. 4D, in order to prevent the low-frequency focus and tracking actuator drive signals from flowing through the relatively low-inductance writing coil 43, a small filter capacitor may be connected in series with the writing coil 43, between the writing coil 43 and the node to the tracking actuator coil 31b and the focus actuator coil 31a, as will be explained later in more detail.

The electrical circuit configurations discussed above are all suitable for communicating the write and drive signals to coils mounted on a moving platform. Regarding the embodiments having four spring wires, the embodiment illustrated in FIG. 4C has an inherent advantage of being simple and not having potential problems regarding crosstalk since exactly one spring wire is used as common conductor to all coils, which may therefore be connected to a hard reference voltage such as mass. Of those embodiments where both conductors to the writing coil 43 are used as common conductor, the embodiment illustrated in FIG. 4E is the most simple one, and crosstalk-prevention can be implemented relatively easily, as will be explained hereinafter. However, it is repeated that all electrical circuit configurations discussed above are suitable for communicating the write and drive signals to coils mounted on a moving platform, and that in practice a designer may choose any of those circuit configurations depending on, inter alia, electrical resistance of the spring wires, possible parasitic capacities, current requirements of the actuator, distance between drivers and coils, and possible even just designer's taste.

In many cases, the electrical circuit configurations discussed above may be sufficient for adequately communicating the write and drive signals to the intended recipient. In this respect, it is noted that the writing coil drive signals have a relatively high frequency (in the MHz range), whereas the actuator coil drive signals have a relatively low frequency (in the kHz range). The high inductance of the actuator coil will usually effectively block the relatively high-frequency writing coil drive signals, and/or the actuator will simply not respond mechanically to the relatively high-frequency writing coil drive signals. On the other hand, the relatively low inductance of the writing coil may be insufficient to reliably block the relatively low-frequency actuator coil drive signals. Thus, it may be found desirable or even necessary to provide an additional filter for effecting a better separation between said signals. This is illustrated in FIG. 2, where the platform 30 carries a filter 50. Input wires 51 connect said spring wires to an input of the filter 50; in FIG. 2, only two spring wires 22a, 22b and corresponding input wires 51a, 51b are shown. First output wires 52 connect a first output of the filter 50 to the actuator coils 31; in FIG. 2, only two of such first output wires 52a, 52b are shown. Second output wires 53a, 53b connect a second output of the filter 50 to the writing coil 43.

In a simple embodiment, the actual filter 50 consist of only one component, i.e. a capacitor connected in series with the writing coil 43. FIG. 5 is a diagram schematically illustrating this embodiment of the filter 50 for the situation of the actuator embodiment illustrated in FIG. 4E. Since in this case the tracking actuator coil 31b is completely separate from the focus actuator coil 31a and from the writing coil 43, the tracking actuator coil 31b is omitted from FIG. 5.

The filter 50 has an input 54 with input terminals 54a, 54b, connected to said input wires 51a, 51b, respectively (see FIG. 2). The filter 50 has a first output 55 with first output terminals 55a, 55b, connected (via said first output wires 52a, 52b-FIG. 2) to the terminals of the focus actuator coil 31a. The filter 50 has a second output 56 with second output terminals 56a, 56b, connected (via said second output wires 53a, 53b-FIG. 2) to the terminals of the writing coil 43.

In FIG. 5, a specific embodiment of the writing coil 43 is represented by a simplified electrical replacement circuit, which comprises a parallel arrangement of a capacitance 43C and a series arrangement of a resistance 43R and an inductance 43L, coupled between said two output terminals 56a, 56b. Further, a specific embodiment of the focus actuator coil 31a is represented by a simplified electrical replacement circuit, which comprises a parallel arrangement of a capacitance 31C and a resistance 31R and an inductance 31L, coupled between said two first output terminals 55a, 55b.

First output terminals 55a, 55b are connected to input terminals 54a, 54b, respectively.

The filter 50 further comprises a filter capacitor 59, connected in series between a first input terminal 54a and a first one 56a of second output terminals. The other one 56b of second output terminals is connected to a second input terminal 54b. Second input terminal 54b may be connected to mass, as shown.

In a specific embodiment, the writing coil 43 could be represented by the following parameters:
43L: 18 nH
43R: 2.5 Ω
43C: 0.32 pF
   Further, the focus actuator coil 31a could be represented by the following parameters:
31L: 52 pH
31R: 8.5 kg
31C: 31 pF
   For this specific embodiment, a filter 50 was designed having a filter capacitor 59 of 10 nF.

The operation of the filter 50 will be clarified by the following description of the frequency characteristic.

At very low frequencies, the capacitors 31C and 59 can be considered as non-conductive, and all current flows through the inductance 31L of the actuator coil 31a, in view of the fact that the impedance of the inductor 31L is much lower than the impedance of resistance 31R and capacitance 31C.

If the frequency is increased, the impedance of the inductor 31L will rise whereas the impedances of the capacitors 31C and 59 will decrease. At a certain first transition frequency f_{T1}, the impedance of the inductor 31L will become approximately equal to the impedance of the filter capacitor 59. This first transition frequency f_{T1} is determined by the following formula (1):
f_{T1}=(2π√(L_{31L}·C₅₉))⁻¹ (1)
With the component values as given in this example, this first transition frequency f_{T1} will be approximately 220 kHz.

If the frequency is increased further, the impedance of the inductance 31L of the actuator coil 31a will rise further whereas the impedances of the capacitors 31C and 59 will decrease further. Thus, the current through the actuator coil 31a will decrease, and the current will mainly flow through the filter capacitor 59 and through the writing coil inductor 43L. At a certain second transition frequency f_{T2}, the rising impedance of the inductance 31L of the actuator coil 31a will become approximately equal to the impedance of the capacitance 31C of the actuator coil 31a. With the component values as given in this example, this second transition frequency f_{T2} will be approximately 4 MHz.

At still higher frequencies, the current will start to flow also through the capacitance 31C of the actuator coil 31a, but still at a lower magnitude than the current through the filter capacitor 59.

A third transition frequency f_{T3} occurs when the impedance of the writing coil inductor 43L becomes approximately equal to the impedance of the capacitance 31C of the actuator coil 31a. With the component values as given in this example, this third transition frequency f_{T3} will be approximately 210 MHz.

Thus, it should be clear that the filter 50 is capable of adequately separating the writing coil drive signals (typically in the order of about 100 MHz, 200 mA) from the actuator coil drive signals (typically in the order of about 1 kHz, 100-300 mA) without disturbing the actuator coil drive signals to a noticeable extent.

In general, the capacitance value of filter capacitor 59 is a design parameter, which can be selected on the basis of the above formula (1), taking the inductance of the actuator coils into account, according to the following formula (2) which can simply be derived from the above formula (1):
C₅₉=(4·π²·f_{T1}²·L_{31L})⁻¹ (2)
With actuator drive signals ranging up to 10 kHz, f_{T1} may for instance be selected in the range of 40-250 kHz. In the case of an actuator coil inductance of 52 μH, C₅₉ may then be selected in the range of 8-300 nF.

It is noted that the capacitance value of the filter capacitor 59 has substantially no influence on the position of the third transition frequency f_{T3}. This third transition frequency f_{T3} is determined by the inductance of the writing coil inductor 43L and the capacitance 31C of the actuator coil 31a according to a formula similar to formula (1). Preferably, the third transition frequency f_{T3} is as high as possible, which translates into the desire to have the parasitic capacitance 31C of the actuator coil 31a be as small as possible.

As already mentioned, an advantage of the first embodiment illustrated in FIG. 4C over the embodiments illustrated in FIGS. 4D-F is that said first embodiment does not need any additional filter components.

It should be clear to a person skilled in the art that the present invention is not limited to the exemplary embodiments discussed above, but that various variations and modifications are possible within the protective scope of the invention as defined in the appending claims.

For instance, in the schematical drawing of FIG. 3 only one objective lens 41 is shown. However, the present invention is also applicable in the case of a high NA (Numerical Aperture) lens assembly, which comprises two or more lens components, as is known per se.

Further, in the schematical drawing of FIG. 3 the coil 43 is shown between the lens 41 and the disc 2; however, the present invention is also applicable in case the coil 43 is mounted on the opposite side of the lens 41 or, in the case of a multiple-lens assembly, between two lens components.

In case five spring wires are available for use as electrical conductor, it is possible to connect writing coil 43 and one actuator coil 31 as illustrated in FIG. 4C (using three spring wires) and to individually connect the other actuator coil 31 as illustrated in FIG. 4B (using two spring wires).

1. Actuator for a magneto optical recording apparatus, comprising:
an actuator base;
a platform;
at least one writing coil supported by said platform;
a plurality of spring wires movably coupling said platform to said actuator base;
wherein at least one of said spring wires is electrically conductive and is connected in series with said writing coil such as to effectively act as conductor for writing coil drive signals.

2. Actuator according to claim 1, further comprising at least one actuator coil supported by said platform;
wherein at least one of said spring wires is electrically conductive and is connected in series with said actuator coil such as to effectively act as conductor for actuator coil drive signals.

3. Actuator according to claim 2, wherein at least one of said spring wires effectively acts as common conductor for writing coil drive signals as well as actuator coil drive signals.

4. Actuator according to claim 3, wherein:
a first electrically conductive spring wire is coupled to a first terminal of said writing coil, and to a first terminal of a focus actuator coil, and to a first terminal of a tracking actuator coil;
a second electrically conductive spring wire is coupled to a second terminal of said writing coil;
a third electrically conductive spring wire is coupled to a second terminal of said focus actuator coil;
a fourth electrically conductive spring wire is coupled to a second terminal of said tracking actuator coil.

5. Actuator according to claim 3, wherein:
a first electrically conductive spring wire is coupled to a first terminal of said writing coil, and to a first terminal of a first actuator coil;
a second electrically conductive spring wire is coupled to a second terminal of said writing coil, and to a first terminal of a second actuator coil;
a third electrically conductive spring wire is coupled to a second terminal of said first actuator coil;
a fourth electrically conductive spring wire is coupled to a second terminal of said second actuator coil.

6. Actuator according to claim 3, wherein:
a first electrically conductive spring wire is coupled to a first terminal of said writing coil, and to a first terminal of a first actuator coil;
a second electrically conductive spring wire is coupled to a second terminal of said writing coil, and to a second terminal of said first actuator coil.

7. Actuator according to claim 6, wherein:
a third electrically conductive spring wire is coupled to a first terminal of a second actuator coil;
a fourth electrically conductive spring wire is coupled to a second terminal of said second actuator coil.

8. Actuator according to claim 6, wherein:
said second electrically conductive spring wire is also coupled to a first terminal of a second actuator coil;
a third electrically conductive spring wire is coupled to a second terminal of said second actuator coil.

9. Actuator according to claim 3, further comprising a filter mounted on said platform, the filter comprising:
an input coupled to said at least one common conductor;
at least one first output coupled to said at least one actuator coil;
at least one second output coupled to said at least one writing coil;
wherein said filter is adapted to substantially pass relatively low-frequency signals to said first output and to substantially pass relatively high-frequency signals to said second output.

10. Actuator according to claim 9, wherein said relatively low-frequency signals are in the order of about 10 kHz and wherein said relatively high-frequency signals are in the order of about 100 MHz.

11. Actuator according to claim 9, wherein said filter comprises a filter capacitor, connected in series between a first input terminal and a first terminal of the second output, and wherein a first terminal of the first output is preferably connected to said first input terminal.

12. Actuator according to claim 11, wherein a first transition frequency is defined by the parallel combination of said filter capacitor and the inductance value of said actuator coil;
wherein a second transition frequency is defined by the parallel combination of the inductance value of said actuator coil and the parasitic capacitance of said actuator coil;
wherein said second transition frequency is higher than said first transition frequency.

13. Actuator according to claim 12, wherein said first transition frequency is higher than 1 kHz, preferably higher than 10 kHz, and more preferably higher than 40 kHz, and most preferably in the range of 40-300 Hz;
and wherein said second transition frequency is lower than 100 MHz, preferably lower than 10 MHz, more preferably lower than 5 MHz, and most preferably in the range of 1-4 MHz.

14. Actuator according to claim 11,
wherein said actuator coil has a resistance value substantially in the order of about 8.5 kΩ;
wherein said actuator coil has a parasitic capacitance value substantially in the order of about 31 pF;
and wherein said filter capacitor has a capacitance value in the range of 8-300 nF, preferably substantially in the order of about 10 nF.

15. Actuator according to claim 14,
wherein said actuator coil has an inductance value substantially in the order of about 50 μH;
and wherein said at least one writing coil has a capacitive impedance substantially in the order of about 0.32 pF parallel to an inductive impedance substantially in the order of about 18 nH in series with a resistive impedance substantially in the order of about 2.5 Ω.

16. Magneto optical recording apparatus, comprising:
receiving means for receiving and rotating a magneto-optically recordable disc;
controllable optical means for directing a controlled laser beam to a portion of the disc;
controllable magnetizing means for applying a controlled magnetic field to an area of the disc;
and an actuator according to claim 1.

17. Filter for use in an actuator according to claim 1, suitable for mounting on a movable platform of such actuator, the filter comprising:
an input;
at least one first output for coupling to an actuator coil;
at least one second output for coupling to an writing coil;
the filter being suitable for receiving actuator coil drive signals as well as writing coil drive signals at its input, for separating said signals from each other, and for outputting said actuator coil drive signals at said first output and for outputting said writing coil drive signals at said second output.

18. Filter according to claim 17, comprising:
a filter capacitor, connected in series between a first input terminal and a first terminal of the second output;
said filter capacitor preferably having a capacitance value substantially in the order of about 10 nF;
the filter preferably having a first terminal of the first output connected to said first input terminal.
